(19) United States
(12) Patent Application Publication
(10) Pub. No.: US 2010/0259483 A1
(43) Pub. Date: Oct. 14, 2010

(54) OPERATING AND DISPLAY SYSTEM FOR A VEHICLE

(75) Inventors: Stefan Becker, Roesrath (DE); Holger Mueller, Koln (DE); Ingo la Tendresse, Koln (DE); Clemens Lango, Dusseldorf (DE); Thorsten Steckstor, Hurth (DE); Johannes Mihm, Koln (DE); Hans Hoffmann, Frechen (DE); Martin Scheck, Pulheim (DE); Clemens Marek, Frechen (DE)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/578,073

(22) Filed: Oct. 13, 2009

(30) Foreign Application Priority Data
Oct. 10, 2008 (DE) 10 2008 050 921.3

(51) Int. Cl. G06F 3/02

(52) U.S. Cl. 345/168

(57) ABSTRACT

The disclosure relates to a display and operator control system in a motor vehicle, including a display panel and an operator control panel with operator control keys and function keys. The display panel is electronically coupled to the operator control panel and has roughly the same outer shape as the operator control panel. Representations of the control and function keys are displayed on the display panel in the same relative positions as the control and function keys are located on the operator control panel. Data input on the keypad of the control panel is displayed on an input panel on the display panel. The operator control panel also has an keypad for inputting of data, the data being shown in an input panel on the display panel. This provides intuitive operator control for the user.

### CROSS-REFERENCE TO RELATED APPLICATIONS

This application claims foreign priority benefits under 35 U.S.C. §119(a)-(d) to DE 10 2008 050 921.3 filed Oct. 10, 2008, which is hereby incorporated by reference in its entirety.

### BACKGROUND

1. Technical Field

The disclosure relates to a display panel and an operator control device for a motor vehicle.

2. Background Art

U.S. Pat. No. 5,821,935 discloses a display panel and operator control device in a motor vehicle in which an operator control panel has operator control keys with a firmly associated functionality, function keys with a function which can be altered by the user and two multifunction switches for the selection of functions from a selection menu. The keys and switches appear as symbols on a display panel.

However, this arrangement allows data which are not prescribed directly in the selection menu or as a function to be input only with difficulty. Generally, this requires the function keys or the selection menu to be used to call an appropriate digit or letter menu, which is time consuming and complicated.

### SUMMARY

An operator control system is disclosed which has an operator control panel with control keys, function keys, and a keypad. It also includes a display panel electronically coupled to the operator control panel and has roughly the same outer shape as the operator control panel. Representations of the control and function keys are displayed on the display panel in the same relative positions as the control and function keys are located on the operator control panel. Data input on the keypad of the control panel is displayed on an input panel on the display panel. The operator control panel and the display panel are mounted in a motor vehicle. The control keys include a navigation system key, a radio key, and a CD key. The keypad is a numeric keypad comprising keys for numerals 0 through 9. The operator control system also has a multifunction button used to control a selection menu displayed on the display panel and a position of the selection menu on the display panel correspond to a position of the multifunction button on the operator control panel. Alternatively, he keypad is used to control the selection menu. The operator control keys are arranged at an edge of the operator control panel and the associated operator control key symbols are arranged as an array of symbols at an edge of the display panel.

Also disclosed is an operator control system, with an operator control panel having a navigation system key, a radio key, a CD key, function keys, and a keypad; and a display panel electronically coupled to the operator control panel and having roughly the same shape as the operator control panel. A navigation system symbol, a radio symbol, and a CD symbol are displayed on the display panel in the same relative positions as the navigation system key, the radio key, and the CD key are positioned on the control panel; and data input on the keypad of the control panel is displayed on an input panel on the display panel.

According to an embodiment of the present disclosure, the operator control and display is improved such that even complex data inputs are possible due to the keys on the operator control panel being in the same relative position as the representations of the keys on the display panel. The operator has direct visual feedback of the keys of the keypad which have been depressed on the display panel. The user can see the physical association between the operation of the numeric keypad on the operator control panel and the appearance of the data in the input panel portion of the display panel.

Data for input are preferably digits, letters or combinations of letters. For the input of digits, the keypad is preferably in the form of a numerical digit block. For the input of letters or combinations of letters, the keypad may be in the form of an alphanumeric digit block (numeric keypad), as is customary on mobile telephones, for example. Other arrangements of the keypad are possible.

In this case, the presentation of the input panel can be matched to the respective function, e.g., the telephone and navigation functions. Under the telephone function, telephone numbers are input via the keypad and displayed on the input panel. However, in the navigation function, the input panel may have a different appearance when inputting addresses via the input panel.

In some embodiments, the operator control panel has a multifunction button used to control a selection menu on the display panel. The selection menu can be used to select many functions—particularly using submenus—more quickly than is possible with the function keys or operator control keys. The position of the multifunction button on the operator control panel corresponds to the position of the selection menu on the display panel.

In one embodiment, the display panel displays either the selection menu or the input panel. The area provided in the display panel for the selection menu and the input panel can then be used entirely to show either the selection menu or the input panel. This allows better recognition by the user. This function is performed in conjunction with operation of the multifunction button or the keypad. When the multifunction button is operated, only the selection menu appears on the display panel. When the keypad is operated, only the input panel appears on the display panel. In both cases, the symbols for the function and operator control keys remain visible and the functions of these keys remain active even when the multifunction button or the keypad is operated. Thus, if input using the multifunction button or keypad needs to be aborted, it is possible at any time to press a function or operator control key to activate or execute the desired function.

In a further embodiment, the display panel displays the selection menu, and the keypad is used to effect menu selection. A direct selection of this kind can be made in the case of a track list for a music CD, for example, by replacing a selection using the multifunction button with direct input of the track number via the keypad.

According to one embodiment, the operator control keys are arranged as an array of keys at the edge of the operator control panel; and the associated operator control key symbols are arranged as an array of symbols at the corresponding edge of the display panel. The function keys are arranged as an array of keys at the top and/or bottom edge of the operator control panel, and the associated function key symbols are arranged as an array of symbols likewise at the associated top and/or bottom edge of the display panel.

The display and operator control system may be produced in any desired combination of the features described herein. In particular, the display panel can show various presentations, splits, symbols and input panels or selection menus for various modes of operation and/or functions.

### BRIEF DESCRIPTION OF THE DRAWINGS

FIG. 1 shows a display panel and an associated operator control panel in a CD mode, according to an embodiment of the disclosure;

FIG. 2 shows a display panel and an associated operator control panel in a CD mode using the multifunction button, according to an embodiment of the disclosure;

FIG. 3 shows a display panel and an associated control panel in a telephone mode with input using the keypad, according to an embodiment of the disclosure; and

FIG. 4 shows a display panel and an associated control panel in a radio mode with a function selection using a function key, according to an embodiment of the disclosure.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations consistent with the present disclosure, e.g., ones in which components are arranged in a slightly different order than shown in the embodiments in the Figures. Those of ordinary skill in the art will recognize that the teachings of the present disclosure may be applied to other applications or implementations.

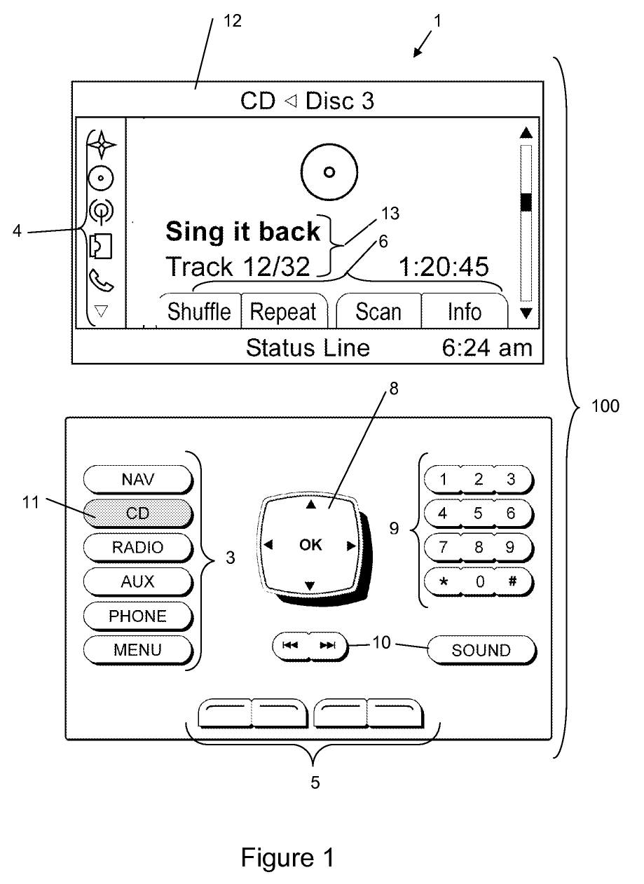

In FIGS. 1-4, the upper portion shows a display panel 1 and the lower portion shows an associated operator control panel 2 with element 100 identifying the and operator control system. These are shown arranged in this manner for illustration purposes only. They may be arranged physically separate at different locations in the motor vehicle. For example the operator control panel may be disposed in a dashboard (not shown) and the operator control panel 2 in a center console (not shown). Alternatively, the display panel 1 and the operator control panel 2 are accommodated physically next to one another.

The left-hand edge of the operator control panel 2 holds an array of operator control keys 3 with six operator control keys for the following modes of operation: navigation, CD player, radio, auxiliary input (AUX), telephone and menu control. Depressing an operator control key results in execution of the corresponding mode of operation directly. The operator control key symbols associated with the operator control keys are shown in the same relative positions on the display panel 1. As shown in FIG. 1, the operator control keys 3 and the operator control symbols are located near a left-hand edge of the operator control panel 2 and the display panel 1, respectively. However, this is a non-limiting example and they can be located anywhere.

The bottom edge of the operator control panel 2 holds an array of function keys 5 with four function keys. The function key symbols 6 associated with the function keys 5 are shown in the same relative position on the display panel 1. It is not an obstruction to the physical association if the display panel 1 additionally displays a status line 7 with additional information below the function key symbols 6. Depending on the selected mode of operation via the operator control keys 3, the function keys 5 have different functions assigned to them, the respective function being displayed in the associated function key symbol.

The operator control panel 2 also has a multifunction button 8 and a keypad 9. Depending on the embodiment, further switches 10 may be arranged on the operator control panel 2.

FIG. 1 shows the display and operator control system in CD mode. Pressing the CD operator control key 11 switches directly to CD mode. The display panel 1 then shows a status display bar 12 indicating CD mode and an information panel 13 with general information relating to the music track which is currently being played.

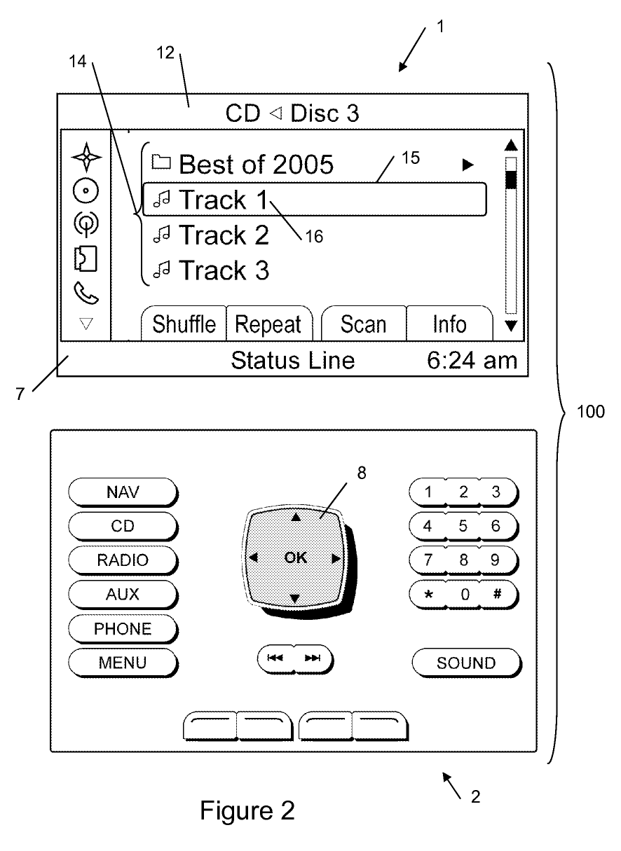

In FIG. 2, the multifunction button 8 is operated in CD mode. The selection menu 14 then automatically appears in the display panel 1. The multifunction button 8 can be used to move a pointer 15 over the individual menu items 16. Pressing the central OK position of the multifunction button 8 selects a menu item 16.

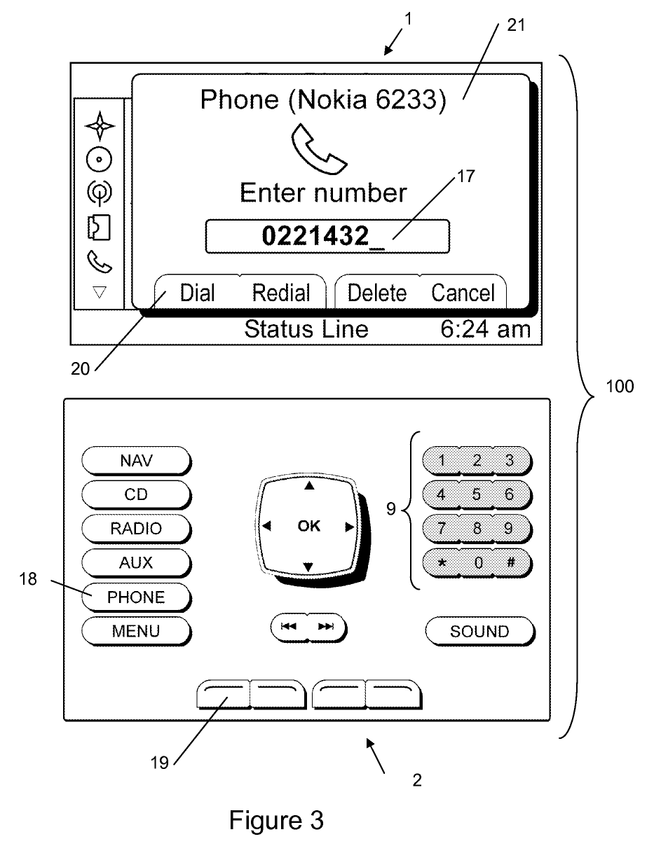

FIG. 3 shows the input of a telephone number 17 in telephone mode. Telephone mode is accessed by depressing a telephone operator control key 18, for example. The functions required for the telephone mode are then automatically stored in the function keys and displayed in the array of function key symbols 6. Pressing the function key 19 for dialing, indicated in the display panel 1 by the function key symbol 20 for dialing, then shows an input panel 21 on the display panel 1. By operating the keys on the keypad 9, it is possible to input the telephone number 17, which appears in the input panel 21.

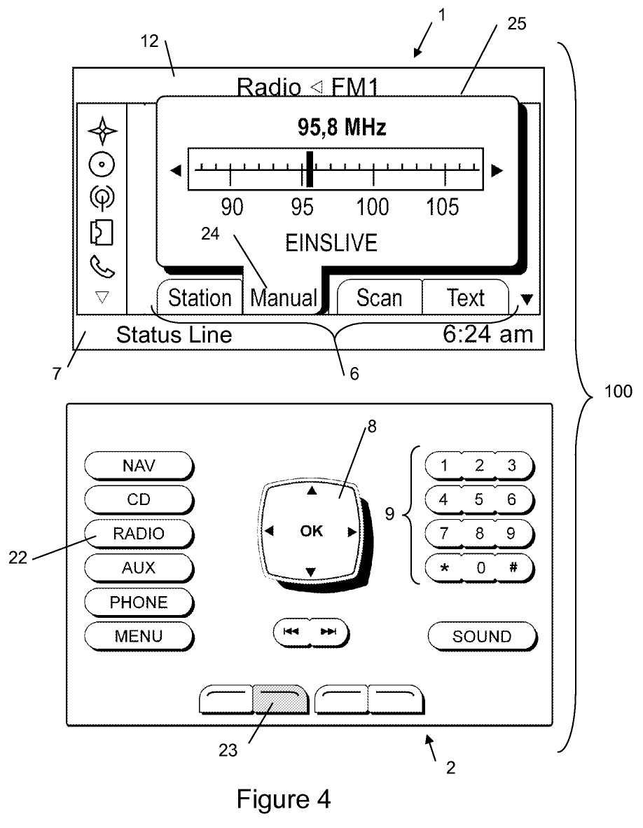

FIG. 4 shows the display and operator control system in radio mode, which is accessed by depressing a radio operator control key 22. In this case, the functions required for the radio mode are automatically stored in the function keys 5 and displayed in the display panel 1 as function key symbols 6. Operating a function key 23 for manual station selection, indicated in the display panel 1 by a function key symbol 24 for manual station selection, then shows an input panel 25 on the display panel 1. This input panel 25 for station selection can be controlled using both the keypad 9, by inputting a particular digit value, and by the multifunction button 8.

While the best mode has been described in detail, those familiar with the art will recognize various alternative designs and embodiments within the scope of the following claims. Where one or more embodiments have been described as providing advantages or being preferred over other embodiments and/or over prior art in regard to one or more desired characteristics, one of ordinary skill in the art will recognize that compromises may be made among various features to achieve desired system attributes, which may depend on the specific application or implementation. These attributes include, but are not limited to: cost, strength, durability, life cycle cost, marketability, appearance, packaging, size, serviceability, weight, manufacturability, ease of assembly, etc. The embodiments described as being less desirable relative to other embodiments with respect to one or more characteristics are not outside the scope of the disclosure as claimed.

What is claimed:

1. An operator control system, comprising:
an operator control panel having control keys, function keys, and a keypad; and
a display panel electronically coupled to the operator control panel and having roughly the same outer shape as the operator control panel,
wherein:
representations of the control and function keys are displayed on the display panel in the same relative positions as the control and function keys are located on the operator control panel; and
data input on the keypad of the control panel is displayed on an input panel on the display panel.

2. The operator control system of claim 1 wherein the operator control panel and the display panel are mounted in a motor vehicle.

3. The system of claim 1 wherein the control keys include at least one of a navigation system key, a radio key, and a CD key.

4. The system of claim 1 wherein the keypad is a numeric keypad comprising keys for numerals 0 through 9.

5. The system of claim 1, further comprising: a multifunction button used to control a selection menu displayed on the display panel and a position of the selection menu on the display panel correspond to a position of the multifunction button on the operator control panel.

6. The system of claim 1 wherein when the display panel is displaying a selection menu, the keypad is used to control the selection menu.

7. The system of claim 1 wherein the operator control keys are arranged at an edge of the operator control panel and the associated operator control key symbols are arranged as an array of symbols at an edge of the display panel.

8. The system of claim 1, further comprising: a status display bar indicating the operator control key selected.

9. An operator control system, comprising:
an operator control panel having a navigation system key, a radio key, a CD key, function keys, and a keypad;
a display panel electronically coupled to the operator control panel and having roughly the same shape as the operator control panel,
wherein:
representations of the function keys are displayed on the display panel in the same relative positions as the function keys are located on the operator control panel;
a navigation system symbol, a radio symbol, and a CD symbol are displayed on the display panel in the same relative positions as the navigation system key, the radio key, and the CD key are positioned on the control panel; and
data input on the keypad of the control panel is displayed on an input panel on the display panel.

10. The system of claim 9, further comprising: a multifunction button used to control a selection menu displayed on the display panel and a position of the selection menu on the display panel correspond to a position of the multifunction button on the operator control panel.

11. The system of claim 9 wherein the keypad controls the selection menu.

12. The system of claim 13 wherein the operator control panel and the display panel are mounted in a motor vehicle.

13. A display and operator control system for a motor vehicle, comprising:
an operator control panel having control keys and function keys; and
a display panel electronically coupled to the operator control panel and having roughly the same outer shape as the operator control panel, wherein representations of the control and function keys are displayed on the display panel in the same relative positions as the control and function keys are located on the operator control panel.

14. The system of claim 13 wherein the operator control panel and the display panel are mounted in a motor vehicle.

15. The system of claim 13, further comprising: a numeric keypad on the operator control panel for data input by the operator and the data input on the keypad is displayed on an input panel on the display panel.

16. The system of claim 13, further comprising: a multifunction button used to control a selection menu displayed on the display panel and a position of the selection menu on the display panel correspond to a position of the multifunction button on the operator control panel.

17. The system of claim 13 wherein the operator control panel and the display panel are mounted adjacent to each other.

18. The system of claim 13 wherein the operator control panel are arranged physically separate.

19. The system of claim 13 wherein the operator control panel is arranged in a dashboard and the operator control panel is arranged in a center console.
